(19) United States
(12) Patent Application Publication
(10) Pub. No.: US 2025/0192178 A1
(43) Pub. Date: Jun. 12, 2025

(54) ALL-SOLID-STATE BATTERY CONTAINING A BINDER HAVING A POLAR FUNCTIONAL GROUP

(71) Applicants: HYUNDAI MOTOR COMPANY, Seoul (KR); KIA CORPORATION, Seoul (KR)

(72) Inventors: Ga Hyeon Im, Hwaseong-si (KR); Yoon Kwang Lee, Suwon-si (KR); So Young Lee, Suwon-si (KR); Yun Sung Kim, Seoul (KR); Kyu Joon Lee, Seoul (KR)

(73) Assignees: HYUNDAI MOTOR COMPANY, Seoul (KR); KIA CORPORATION, Seoul (KR)

(21) Appl. No.: 18/794,681

(22) Filed: Aug. 5, 2024

(30) Foreign Application Priority Data
Dec. 11, 2023 (KR) 10-2023-0178275

(51) Int. Cl. H01M 4/62; H01M 4/02; H01M 4/38

(52) U.S. Cl. CPC H01M 4/622; H01M 4/386; H01M 2004/027

(57) ABSTRACT

An all-solid-state battery includes a negative electrode current collector, a negative electrode layer disposed on the negative electrode current collector, a solid electrolyte layer disposed on the negative electrode layer, a positive electrode layer disposed on the solid electrolyte layer, a positive electrode current collector disposed on the positive electrode layer, and a binder having a polar functional group.

### CROSS REFERENCE TO RELATED APPLICATION

The present application claims priority to Korean Patent Application No. 10-2023-0178275, filed Dec. 11, 2023, the entire contents of which are incorporated herein for all purposes by this reference.

### BACKGROUND

### 1. Field of the Disclosure

The present disclosure relates to an all-solid-state battery containing a binder having a polar functional group.

### 2. Description of the Related Art

The importance of a technology based on a negative electrode to increase the energy density of all-solid-state batteries is being emphasized. Research is actively in progress on silicon-based negative electrode active materials and all-solid-state batteries containing same. However, when being charged and discharged, changes in volume of silicon-based negative electrode active materials are significant. For this reason, there may be a problem in that cracks occur in a negative electrode layer, or the negative electrode layer is separated from a current collector, leading to reversible capacity loss of all-solid-state batteries. Despite the advantage of high charge capacity, silicon-based negative electrode active materials and all-solid-state batteries containing same have the disadvantage of poor cycle characteristics and low capacity retention rate.

Therefore, research and development are actively in progress to increase the binding strength of a binder that forms a negative electrode layer to achieve the charge and discharge stability of all-solid-state batteries containing silicon-based negative electrode active materials. However, all-solid-state batteries containing sulfide-based solid electrolytes have limitations in that a nonpolar solvent compatible with the sulfide-based solid electrolytes must be used during a slurry preparation process. Accordingly, a rubber-based binder free of a polar functional group is typically applied, so there is a problem in that the adhesive strength is extremely low. Additionally, when increasing the amount of a binder to increase adhesive strength, resistance may increase, leading to a deterioration in cell performance.

### SUMMARY

An objective of the present disclosure is to provide an all-solid-state battery having high adhesive strength between a negative electrode layer and a negative electrode current collector.

Another objective of the present disclosure is to provide an all-solid-state battery capable of reducing resistance in a negative electrode layer.

Objectives of the present disclosure are not limited to the objectives mentioned above. The above and other objectives of the present disclosure should become more apparent from the following description and the appended claims.

According to an embodiment of the present disclosure, an all-solid-state battery is provided. The all-solid-state battery includes a negative electrode current collector. The all-solid-state battery also includes a negative electrode layer disposed on the negative electrode current collector a solid electrolyte layer disposed on the negative electrode layer. The all-solid-state battery further includes a positive electrode layer disposed on the solid electrolyte layer and a positive electrode current collector disposed on the positive electrode layer. The negative electrode layer includes a first layer disposed on the negative electrode current collector. The first layer comprises a first negative electrode active material and a first binder. The negative electrode layer also includes a second layer disposed on the first layer. The second layer comprises a second negative electrode active material and a second binder. Each of the first binder and the second binder has a nonpolar main chain and a polar functional group bound to the nonpolar main chain. In the negative electrode layer of the all-solid-state battery, a content of the first binder is higher than a content of the second binder.

Each of the first negative electrode active material and the second negative electrode active material may include a silicon-based negative electrode active material.

The nonpolar main chain may include at least one of butadiene rubber (BR), styrene-butadiene rubber (SBR), or any a combination thereof.

The polar functional group may include at least one of a carboxyl group, an acrylic group, or any a combination thereof.

Each of the first binder and the second binder may have 1 percentage by weight (wt %) to 10 wt % of the polar functional group with respect to the total weight thereof.

A ratio (T₁:T₂) of a thickness (T₁) of the first layer to a thickness (T₂) of the second layer may be in a range of 1:2 to 1:3.

The negative electrode layer may have a thickness in a range of 20 to 100 micrometers (μm).

In the negative electrode layer, a ratio (A₁:A₂) of the content (A₁) of the first binder to the content (A₂) of the second binder may be in a range of 1:0.1 to 1:0.5.

According to embodiments of the present disclosure, an all-solid-state battery is provided having high adhesive strength between a negative electrode layer and a negative electrode current collector while having low resistance in the negative electrode layer.

According to embodiments of the present disclosure, an all-solid-state battery is provided having high energy density.

Effects of the present disclosure are not limited to the effects mentioned above. It should be understood that the effects of the present disclosure include all the effects that can be deduced from the following description.

### BRIEF DESCRIPTION OF THE DRAWINGS

FIG. 1 shows an all-solid-state battery, according to an embodiment of the present disclosure;

FIG. 2 shows a scanning electron microscope (SEM) analysis of a negative electrode layer according to Example 1;

FIG. 3 shows an energy-dispersive X-ray spectroscopy (EDS) analysis of a negative electrode layer according to Example 1;

FIG. 4 shows the capacity retention rate of all-solid-state batteries according to Examples 1 and 2 and Comparative Examples 1 and 2;

FIG. 5 shows rate of negative electrodes of all-solid-state batteries according to Example 1 and Comparative Examples 1 and 2, the results obtained when each negative electrode undergoes lithiation;

FIG. 6 shows rate of negative electrodes of all-solid-state batteries according to Example 1 and Comparative Examples 1 and 2, the results obtained when each negative electrode undergoes dilithiation; and

FIG. 7 shows the capacity retention rate for each rate of the all-solid-state batteries according to Examples 1 and 2 and Comparative Examples 1 and 2.

### DETAILED DESCRIPTION

The above objectives and other objectives, features, and advantages of the present disclosure should be more readily understood from the embodiments described below and the accompanying drawings. However, the present disclosure is not limited to the embodiments described herein and may be embodied in other forms. The embodiments described herein are provided so that the disclosure is made thorough and complete and that the spirit of the present disclosure is fully conveyed to those having ordinary skill in the art to which the present disclosure pertains. Throughout the drawings, like elements are denoted by like reference numerals. In the accompanying drawings, the dimensions of the structures are larger than actual sizes for clarity of the present disclosure. Terms such as “first,” “second,” etc., used herein may be used to describe various components, but the components should not be construed as being limited to the terms. These terms are used only for the purpose of distinguishing a component from another component. For example, without departing from the scope of the present disclosure, a first component may be referred to as a second component, and a second component may be also referred to as a first component.

As used herein, the singular forms “a,” “an,” and “the” are intended to include the plural forms as well unless the context clearly indicates otherwise. It should be further understood that the terms “comprises,” “includes,” or “has,” and the like, when used herein specify the presence of stated features, regions, integers, steps, operations, elements, and/or components. These terms do not preclude the presence or addition of one or more other features, regions, integers, steps, operations, elements, components, and/or combinations thereof. It should also be understood that when an element such as a layer, film, area, or sheet is referred to as being “on” another element, the element may be directly on the other element, or one or more intervening elements may be present therebetween. Similarly, when an element such as a layer, film, area, or sheet is referred to as being “under” another element, the element may be directly under the other element, or intervening elements may be present therebetween.

Unless otherwise specified, all numbers, values, and/or representations that express the amounts of components, reaction conditions, polymer compositions, and mixtures used herein should be approximations taken as including various uncertainties affecting measurement that inherently occur in obtaining these values, among others, and thus should be understood to be modified by the term “about” in all cases. Furthermore, when a numerical range is disclosed in this specification, the range is continuous, and includes all values from the minimum value of said range to the maximum value thereof, unless otherwise indicated. Moreover, when such a range pertains to integer values, all integers including the minimum value to the maximum value are included, unless otherwise indicated.

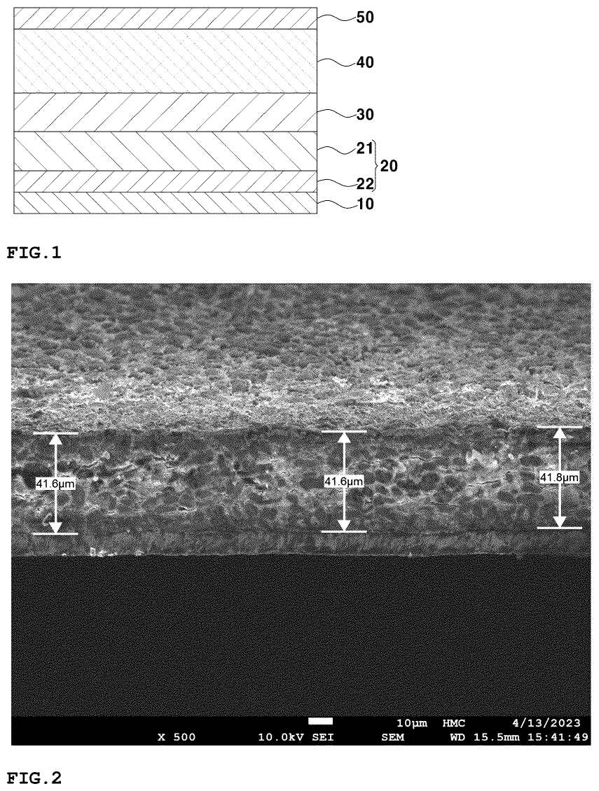

FIG. 1 shows an all-solid-state battery, according to an embodiment of the present disclosure. The all-solid-state battery may include a negative electrode current collector 10 and a negative electrode layer 20 disposed on the negative electrode current collector 10. The all-solid-state battery may also include a solid electrolyte layer 30 disposed on the negative electrode layer 20 and a positive electrode layer 40 disposed on the solid electrolyte layer 30. The all-solid-state battery may additionally include a positive electrode current collector 50 disposed on the positive electrode layer 40.

The negative electrode current collector 10 may be an electrically conductive substrate having a plate-like form. For example, the negative electrode current collector 10 may have a form of a sheet, thin film, or foil.

The thickness of the negative electrode current collector 10 is not particularly limited but may be, for example, in a range of 1 μm to 500 μm.

The negative electrode current collector 10 may contain copper (Cu), nickel (Ni), stainless steel, or the like.

The negative electrode layer 20 may include a first layer 21 disposed on the negative electrode current collector 10 and a second layer 22 disposed on the first layer 21. The negative electrode layer 20 may include a negative electrode active material, a solid electrolyte, a binder, or the like. Hereinafter, the negative electrode active material, the solid electrolyte, and the binder contained in the first layer 21 are referred to as a first negative electrode active material, a first solid electrolyte, and a first binder, respectively. Additionally, the negative electrode active material, the solid electrolyte, and the binder contained in the second layer 22 are referred to as a second negative electrode active material, a second solid electrolyte, and a second binder, respectively. However, what is meant by the negative electrode active material, solid electrolyte, and binder used when describing the negative electrode layer 20 should be apparent from the context.

The first layer 21 may have a structure in a layer form being in physical contact with the negative electrode current collector 10. The first layer 21 has a high binder content, thus enhancing the adhesive strength between the negative electrode layer 20 and the negative electrode current collector 10.

The first layer 21 may contain the first negative electrode active material, the first solid electrolyte, and the first binder.

The first negative electrode active material may include at least one selected from the group comprising or consisting of a silicon-based negative electrode active material, a carbon-based negative electrode active material, or any combination thereof.

The silicon-based negative electrode active material may include at least one selected from the group comprising or consisting of silicon (Si), silicon oxide (SiOₓ) (0<x<2), a Si-containing alloy, or any combination thereof. The Si-containing alloy may include an alloy of Si and at least one element from among an alkali metal, an alkaline earth metal, a Group 13 element, a Group 14 element, a transition metal, a rare-earth element, or any combination thereof.

The carbon-based negative electrode active material may be graphite, such as mesocarbon microbeads (MCMB) and highly oriented graphite (HOPG), or amorphous carbon, such as hard carbon and soft carbon.

The negative electrode active material may be a composite of the silicon-based and the carbon-based negative electrode active materials. For example, the surface of the carbon-based negative electrode active material may be coated with the silicon-based negative electrode active material. As another example, the surface of the silicon-based negative electrode active material may be coated with the carbon-based negative electrode active material.

The first solid electrolyte may include at least one selected from the group comprising or consisting of an oxide-based solid electrolyte, a sulfide-based solid electrolyte, or any combination thereof. Additionally, the solid electrolyte may be crystalline, amorphous, or in a combined form thereof.

Examples of the oxide-based solid electrolyte may include a perovskite-type LLTO (Li₃ₓLa_{2/3-x}TiO₃), a phosphate-based NASICON-type LATP (Li₁₊ₓAlₓTi₂₋ₓ(PO₄)₃), or the like.

Examples of the sulfide-based solid electrolyte may include Li₂S—P₂S₅, Li₂S—P₂S₅—LiI, Li₂S—P₂S₅—LiCl, Li₂S—P₂S₅—LiBr, Li₂S—P₂S₅—Li₂O, Li₂S—P₂S₅—Li₂O—LiI, Li₂S—SiS₂, Li₂S—SiS₂—LiI, Li₂S—SiS₂—LiBr, Li₂S—SiS₂—LiCl, Li₂S—SiS₂—B₂S₃—LiI, Li₂S—SiS₂—P₂S₅—LiI, Li₂S—B₂S₃, Li₂S—P₂S₅—ZₘSₙ (where m and n are each independently a positive integer, and Z is one among germanium (Ge), zinc (Zn), or gallium (Ga)), Li₂S—GeS₂, Li₂S—SiS₂—Li₃PO₄, Li₂S—SiS₂-LiₓMO_{y} (where x and y are each independently a positive integer, and M is one among phosphorus (P), Si, Ge, boron (B), aluminum (Al), Ga, and indium (In)), Li₁₀GeP₂S₁₂, or the like.

The first solid electrolyte may include a sulfide-based solid electrolyte having an argyrodite crystal structure. The sulfide-based solid electrolyte having the argyrodite crystal structure may include at least one of Li_{7-y}PS_{6-y}Ha_{y} (where Ha includes chlorine (Cl), bromine (Br), or iodine (I), and 0<y≤2), Li_{7-z}PS_{6-z}(Ha1_{1-b}Ha2_{b})_{z} (where Ha1 and Ha2 are different from each other and each independently includes Cl, Br, or I, 0<b<1, and 0<z≤2), or any combination thereof.

The first binder may have a nonpolar main chain and a polar functional group bound to the main chain. With the use of a polymer having a polar functional group as the first binder, the adhesive strength between each component, such as the first negative electrode active material, the first solid electrolyte, or the like, and the adhesive strength between the first layer 21 and the negative electrode current collector 10 may be enhanced.

The nonpolar main chain may include at least one selected from the group comprising or consisting of butadiene rubber (BR), styrene-butadiene rubber (SBR), or any combination thereof.

The polar functional group may include at least one selected from the group comprising or consisting of a carboxyl group, an acrylic group, or any combination thereof. The acrylic group may include a “—C═O” group and a “—C═C—” group. For example, the acrylic group may refer to a portion represented by Formula 1.

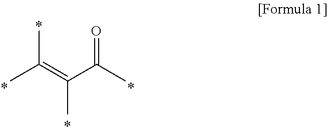

Alternatively, the acrylic group may refer to a portion represented by Formula 2.

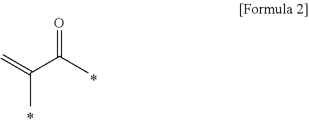

In Formulas 1 and 2, * may mean a site connected to the nonpolar main chain. Further, when at least one * is connected to the nonpolar main chain, the remainder may include hydrogen or an alkyl group having 1 to 3 carbon atoms.

The first binder may contain 1 percentage by weight (wt %) to 10 wt % of the polar functional group with respect to the total weight thereof. When the content of the polar functional group is lower than 1 wt %, the effect of enhancing adhesive strength may be insignificant. On the contrary, when the content of the polar functional group exceeds 10 wt %, side reactions with sulfide-based solid electrolytes may occur.

The second layer 22 may be a layer-form structure disposed on the first layer 21. The second layer 22 has a low binder content. Accordingly, the resistance caused by the binder in the negative electrode layer 20 may be reduced.

The second layer 22 may include the second negative electrode active material, the second solid electrolyte, and the second binder.

The second negative electrode active material may be the same as or different from the first negative electrode active material. The second negative electrode active material may include at least one selected from the group comprising or consisting of a silicon-based negative electrode active material, a carbon-based negative electrode active material, or any combination thereof. The silicon-based negative electrode active material, the carbon-based negative electrode active material. The composite material thereof may be the same as described above.

The second solid electrolyte may be the same as or different from the first solid electrolyte. The second solid electrolyte may include at least one selected from the group comprising or consisting of an oxide-based solid electrolyte, a sulfide-based solid electrolyte, or any combination thereof. Additionally, the solid electrolyte may be crystalline, amorphous, or in a combined form thereof. The oxide-based solid electrolyte and the sulfide-based solid electrolyte are as described above.

The second binder may have a nonpolar main chain and a polar functional group bound to the main chain. The second binder may be the same as or different from the first binder. The nonpolar main chain and the polar functional group are as described above.

The second binder may contain 1 wt % to 10 wt % of the polar functional group with respect to the total weight thereof. When the content of the polar functional group is lower than 1 wt %, the effect of enhancing adhesive strength may be insignificant. On the contrary, when the content of the polar functional group exceeds 10 wt %, side reactions with sulfide-based solid electrolytes may occur.

Embodiments of the present disclosure may enhance the adhesive strength between the negative electrode layer 20 and the negative electrode current collector 10 while reducing the resistance in the negative electrode layer 20. To this end, a ratio (A₁:A₂) of the content (A₁) of the first binder to the content (A₂) of the second binder in the negative electrode layer 20 may be adjusted to be in a range of 1:0.1 to 1:0.5. While the adhesive strength between the negative electrode layer 20 and the negative electrode current collector 10 is enhanced by increasing the content of the first binder contained in the first layer 21, being in direct contact with the negative electrode current collector 10, the resistance in the negative electrode layer 20 may be reduced by reducing the content of the second binder contained in the second layer 22.

On the other hand, to minimize the resistance in the negative electrode layer 20, a ratio (T₁:T₂) of the thickness (T₁) of the first layer 21 to the thickness (T₂) of the second layer 22 may be adjusted to be in a range of 1:2 to 1:3. The resistance in the negative electrode layer 20 may be lowered by making the thickness of the second layer 22, having a low binder content, larger.

The thickness of the negative electrode layer 20 may be in a range of 20 micrometers (μm) to 100 μm. When the thickness of the negative electrode layer 20 exceeds 100 μm, the energy density of the all-solid-state battery may be reduced.

The negative electrode layer 20 may contain 60 wt % to 80 wt % of the negative electrode active material, 10 wt % to 35 wt % of the solid electrolyte, and 1 wt % to 10 wt % of the binder. However, the content of each component is not limited to the above numerical range and may be appropriately adjusted depending on the capacity and performance of the desired all-solid-state battery. The content of the negative electrode active material may refer to the total content of the first and second negative electrode active materials, the content of the solid electrolyte may refer to the total content of the first and second solid electrolytes, and the content of the binder may refer to the total content of the first and second binders.

The solid electrolyte layer 30 may have a sheet form having at least two main surfaces facing each other. Each of the two main surfaces may be a plane in mathematics, and a part thereof may also include a uniformly curved surface. Alternatively, protrusions and depressions formed during the formation of the solid electrolyte layer 30 may be included. In this regard, the sheet form is not limited to a relatively thin cuboid form.

In the sheet-form solid electrolyte layer 30, a distance between the two main surfaces facing each other may be the thickness of the solid electrolyte layer 30. The length of a first direction (for example, a width direction) perpendicular to the thickness direction of the solid electrolyte layer 30 is larger than the thickness thereof. Additionally, the length of a second direction (for example, a length direction) orthogonal to both the thickness direction of the solid electrolyte layer 30 and the first direction is larger than the thickness thereof.

The thickness of the solid electrolyte layer 30 is not particularly limited but may be in a range of 1 μm to 100 μm. The thickness of the solid electrolyte layer 30 may mean an average value obtained when measuring a measurement target at five points.

The solid electrolyte layer 30 may contain a solid electrolyte having lithium-ion conductivity, a binder, or the like.

The solid electrolyte may be the same as or different from the solid electrolyte contained in the negative electrode layer 20. The solid electrolyte may include at least one selected from the group comprising or consisting of an oxide-based solid electrolyte, a sulfide-based solid electrolyte, or any combination thereof. Additionally, the solid electrolyte may be crystalline, amorphous, or in a combined form thereof.

Examples of the oxide-based solid electrolyte may include a perovskite-type LLTO (Li₃ₓLa_{2/3-x}TiO₃), a phosphate-based NASICON-type LATP (Li₁₊ₓAlₓTi₂₋ₓ(PO₄)₃), or the like.

Examples of the sulfide-based solid electrolyte may include Li₂S—P₂S₅, Li₂S—P₂S₅—LiI, Li₂S—P₂S₅—LiCl, Li₂S—P₂S₅—LiBr, Li₂S—P₂S₅—Li₂O, Li₂S—P₂S₅—Li₂O—LiI, Li₂S—SiS₂, Li₂S—SiS₂—LiI, Li₂S—SiS₂—LiBr, Li₂S—SiS₂—LiCl, Li₂S—SiS₂—B₂S₃—LiI, Li₂S—SiS₂—P₂S₅—LiI, Li₂S—B₂S₃, Li₂S—P₂S₅—ZₘSₙ (where m and n are each independently a positive integer, and Z is one among Ge, Zn, and Ga), Li₂S—GeS₂, Li₂S—SiS₂—Li₃PO₄, Li₂S—SiS₂-LiₓMO_{y} (where x and y are each independently a positive integer, and M is one among P, Si, Ge, B, Al, Ga, and In), Li₁₀GeP₂S₁₂, or the like.

The solid electrolyte may include a sulfide-based solid electrolyte having an argyrodite crystal structure. The sulfide-based solid electrolyte having the argyrodite crystal structure may include at least one selected from the group comprising or consisting of Li_{7-y}PS_{6-y}Ha_{y} (where Ha includes Cl, Br, or I, and 0<y≤2), Li_{7-z}PS_{6-z}(Ha1_{1-b}Ha2_{b})_{z} (where Ha1 and Ha2 are different from each other and each independently includes Cl, Br, or I, 0<b<1, and 0<z≤2), or any combination thereof.

Examples of the binder may include butadiene rubber (BR), nitrile butadiene rubber (NBR), hydrogenated nitrile butadiene rubber (HNBR), polyvinylidene fluoride (PVDF), polytetrafluoroethylene (PTFE), carboxymethyl cellulose (CMC), or the like. The binder in the solid electrolyte layer 30 may be present in a particle-like form, a linear form, or the like.

The positive electrode layer 40 may include a positive electrode active material, a solid electrolyte, a conductive additive, a binder, or the like.

The positive electrode active material may include a lithium transition metal oxide that stores and releases lithium.

The lithium transition metal oxide may include any material commonly known in the art to which the present disclosure pertains. For example, the lithium transition metal oxide may include LiNiₓ₁Coₓ₂Mnₓ₃O₂ (0.65≤x1≤0.85, 0.05<x2<0.25, 0.03<x3<0.2, and x+x2+x3=1).

The mean particle diameter D₅₀ of the positive electrode active material is not particularly limited but may be, for example, in a range of 1 to 20 μm. The mean particle diameter (D₅₀) of the positive electrode active material may be measured using a currently available laser diffraction scattering-type particle size distribution analyzer, for example, a particle size distribution measuring equipment purchased from Microtrac. Additionally, 200 particles may be randomly extracted from an electron micrograph to calculate the mean particle diameter.

The positive electrode active material may be coated with an alkali metal oxide.

The alkali metal oxide may include an alkali metal element, a transition metal element, and/or a substitution element.

The alkali metal element may include at least one selected from the group comprising or consisting of lithium (Li), sodium (Na), potassium (K), or any combination thereof. In an embodiment, the alkali metal element includes lithium (Li).

The transition metal element may include any alkali metal oxide commonly used in the art to which the present disclosure pertains. For example, the transition metal element may include at least one selected from the group comprising or consisting of niobium (Nb), tantalum (Ta), zirconium (Zr), or any combination thereof.

The solid electrolyte may be responsible for lithium-ion movement in the positive electrode layer 40. The solid electrolyte may be the same as or different from the solid electrolyte of the negative electrode layer 20 and the solid electrolyte layer 30.

The solid electrolyte may include at least one selected from the group comprising or consisting of an oxide-based solid electrolyte, a sulfide-based solid electrolyte, or any combination thereof. Additionally, the solid electrolyte may be crystalline, amorphous, or in a combined form thereof.

Examples of the oxide-based solid electrolyte may include a perovskite-type LLTO (Li₃ₓLa_{2/3-x}TiO₃), a phosphate-based NASICON-type LATP (Li₁₊ₓAlₓTi₂₋ₓ (PO₄)₃), or the like.

Examples of the sulfide-based solid electrolyte may include Li₂S—P₂S₅, Li₂S—P₂S₅—LiI, Li₂S—P₂S₅—LiCl, Li₂S—P₂S₅—LiBr, Li₂S—P₂S₅—Li₂O, Li₂S—P₂S₅—Li₂O—LiI, Li₂S—SiS₂, Li₂S—SiS₂—LiI, Li₂S—SiS₂—LiBr, Li₂S—SiS₂—LiCl, Li₂S—SiS₂—B₂S₃—LiI, Li₂S—SiS₂—P₂S₅—LiI, Li₂S—B₂S₃, Li₂S—P₂S₅—ZₘSₙ (where m and n are each independently a positive integer, and Z is one among Ge, Zn, and Ga), Li₂S—GeS₂, Li₂S—SiS₂—Li₃PO₄, Li₂S—SiS₂-LiₓMO_{y} (where x and y are each independently a positive integer, and M is one among P, Si, Ge, B, Al, Ga, and In), Li₁₀GeP₂S₁₂, or the like.

The solid electrolyte may include a sulfide-based solid electrolyte having an argyrodite crystal structure. The sulfide-based solid electrolyte having the argyrodite crystal structure may include at least one selected from the group comprising or consisting of Li_{7-y}PS_{6-y}Ha_{y} (where Ha includes Cl, Br, or I, and 0<y≤2), Li_{7-z}PS_{6-z} (Ha1_{1-b}Ha2_{b})_{z} (where Ha1 and Ha2 are different from each other and each independently includes Cl, Br, or 1, 0<b<1, and 0<z≤2), or any combination thereof.

Examples of the conductive additive may include carbon black, conductive graphite, ethylene black, graphene, carbon nanotubes, carbon nanofibers, vapor-grown carbon fibers, or the like.

Examples of the binder may include butadiene rubber (BR), nitrile butadiene rubber (NBR), hydrogenated nitrile butadiene rubber (HNBR), polyvinylidene fluoride (PVDF), polytetrafluoroethylene (PTFE), carboxymethyl cellulose (CMC), or the like. The binder in the positive electrode layer 40 may be present in a particle-like form, a linear form, or the like.

The positive electrode layer 40 may contain 70 wt % to 90 wt % of the positive electrode active material, 10 wt % to 15 wt % of the solid electrolyte, 1 wt % to 5 wt % of the conductive additive, and 1 wt % to 5 wt % of the binder. However, the content of each component may be appropriately adjusted in consideration of the capacity and efficiency of the desired all-solid-state battery.

The thickness of the positive electrode layer 40 is not particularly limited but may be in a range of 1 μm to 100 μm. The thickness of the positive electrode layer 40 may mean an average value obtained when measuring a measurement target at five points. Additionally, the thickness of the positive electrode layer 40 may mean the thickness of the all-solid-state battery in a discharged state.

The positive electrode current collector 50 may include an electrically conductive substrate having a plate-like form. For example, the positive electrode current collector 10 may have a form of a sheet, thin film, or foil.

The positive electrode current collector 50 may include an aluminum foil.

The thickness of the positive electrode current collector 50 is not particularly limited but may be, for example, in a range of 1 μm to 500 μm.

Another embodiment of the present disclosure is described in more detail below through the following examples. The following examples are only examples to enhance the understanding of the present disclosure. The scope of the present disclosure is not limited thereto.

### Example 1

An all-solid-state battery having the same structure as shown in FIG. 1 was manufactured.

A slurry containing a silicon-based negative electrode active material, a sulfide-based solid electrolyte, and a first binder was applied and dried on a negative electrode current collector to form a first layer. A slurry containing a silicon-based negative electrode active material, a sulfide-based solid electrolyte, and a second binder was applied and dried on the first layer to form a second layer. As the first and second binders, styrene-butadiene rubber (SBR) with a substituted acrylic group as a polar functional group was used. Table 1 shows the thickness and thickness ratio of the first and second layers and the ratio of the binders in a negative electrode layer.

A solid electrolyte layer containing a sulfide-based solid electrolyte, a positive electrode layer, and a positive electrode current collector were sequentially stacked on such a formed negative electrode layer to complete the manufacturing of the all-solid-state battery.

### Example 2

An all-solid-state battery was manufactured in the same manner as in Example 1, except for varying the thickness and thickness ratio of the first and second layers as shown in Table 1.

### Comparative Example 1

A slurry containing a silicon-based negative electrode active material, a sulfide-based solid electrolyte, and a binder was applied and dried on a negative electrode current collector to form a negative electrode layer in a single-layer form. The silicon-based negative electrode active material and sulfide-based solid electrolyte used were the same as those used in Example 1. Butadiene rubber was used as the binder. Table 1 shows the thickness of the negative electrode layer and binder contents.

A solid electrolyte layer, a positive electrode layer, and a positive electrode current collector were stacked on such a formed negative electrode in the same manner as in Example 1 using the same materials to complete the manufacturing of an all-solid-state battery.

### Comparative Example 2

An all-solid-state battery was manufactured in the same manner as in Comparative Example 1 using the same materials, except for using styrene-butadiene rubber (SBR) with the substituted acrylic group as the binder in the same manner as in Example 1.

The adhesive strength between the negative electrode layer and the negative electrode current collector, according to Examples 1 and 2 and Comparative Examples 1 and 2, was measured as follows. The negative electrode layer and the negative electrode current collector were inserted between a polyethylene terephthalate (PET) film having a thickness of about 100 μm and then compressed for about 1 second using a flat press under the following conditions: a temperature of about 60° Celsius (C) and a pressure of 6.5 mega pascals (Mpa). The resulting product was attached to a slide glass and then mounted on the holder of a UTM device. The force required to detach the negative electrode layer and the negative electrode current collector was measured by applying a force at a measurement speed of 300 mm/min. The results thereof are shown in Table 2.

The resistance in the negative electrode layers, according to Examples 1 and 2 and Comparative Examples 1 and 2, was measured by DC Load measurement. Specifically, while discharging the all-solid-state battery for several seconds, the open-circuit voltage (OCV) level was measured using a voltmeter. A load was connected to the all-solid-state battery and the voltage level was then measured. The resistance value of the negative electrode layer was calculated using the voltage level difference occurring at this time. The results thereof are shown in Table 2.

TABLE 1

| | Classification | | | | |
|---|---|---|---|---|---|
| | Structure | Thickness | Thickness | Binder | |
| | of | of | ratio in | content in | |
| | negative | negative | negative | negative | Content |
| | electrode | electrode | electrode | electrode | ratio of |
| | layer | layer | layer¹⁾ | layer | binders²⁾ |
| Example 1 | Double | First | 1:2 | 3 wt % | 1:0.5 |
| | layer | layer: 13 | | | |
| | | μm, | | | |
| | | Second | | | |
| | | layer: | | | |
| | | 28 μm | | | |
| Example 2 | Double | First | 1:3 | 3 wt % | 1:0.5 |
| | layer | layer: 10 | | | |
| | | μm, | | | |
| | | Second | | | |
| | | layer: | | | |
| | | 32 μm | | | |
| Comparative | Single | 43 μm | — | 2 wt % | — |
| Example 1 | layer | | | | |
| Comparative | Single | 42 μm | — | 2 wt % | — |
| Example 2 | layer | | | | |

¹⁾The thickness ratio in the negative electrode layer means a ratio of the thickness of the first layer to the thickness of the second layer.
²⁾The content ratio of the binders means a ratio of the content of the first binder to the content of the second binder in the negative electrode layer.

TABLE 2

Classification

| | Adhesive strength | |
|---|---|---|
| | between negative | |
| | electrode layer and | |
| | negative electrode | Resistance in |
| | current collector | negative electrode |
| | [gf/mm] | layer [Ω] |
| Example 1 | 1.20 | 9.498 |
| Example 2 | 1.20 | 8.811 |
| Comparative | 0.26 | 10.604 |
| Example 1 | | |
| Comparative | 0.99 | 10.901 |
| Example 2 | | |

From Table 2, it can be seen that in the case of Examples 1 and 2 and Comparative Example 2, where the binder having the polar functional group is used, the adhesive strength between the negative electrode layer and the negative electrode current collector is significantly superior to that in the case of Comparative Example 1. On the other hand, it can be seen that in the case of Examples 1 and 2, where the content ratio of the binders is adjusted by dividing the negative electrode layer into a double layer composed of the first and second layers, the resistance in the negative electrode layer is significantly lower than that in the case of Comparative Example 2.

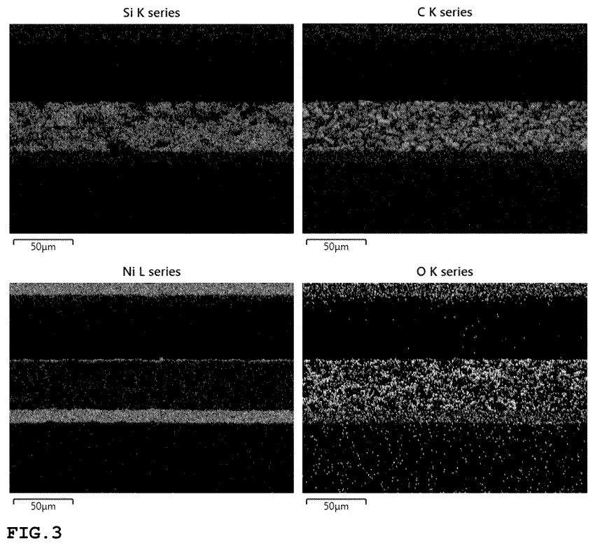

FIG. 2 shows an analysis result of the negative electrode layer according to Example 1, where the analysis is performed with a scanning electron microscope (SEM). FIG. 3 shows analysis results of the negative electrode layer according to Example 1, where the analysis is performed with energy-dispersive X-ray spectroscopy (EDS). From FIGS. 2 and 3, it can be seen that the first and second layers, according to Example 1, are well-formed without causing interfacial separation.

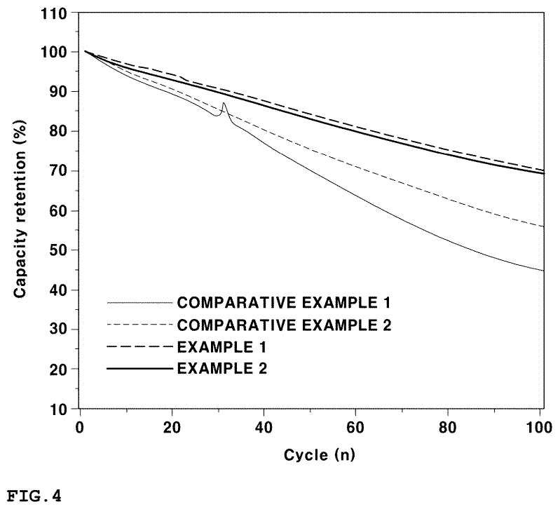

FIG. 4 shows measurement results of the capacity retention rate of the all-solid-state batteries according to Examples 1 and 2 and Comparative Examples 1 and 2. The measurement temperature was adjusted to about 30° C. The capacity retention rate of the all-solid-state batteries, according to Examples 1 and 2, is higher than that of the all-solid-state batteries, according to Comparative Examples 1 and 2.

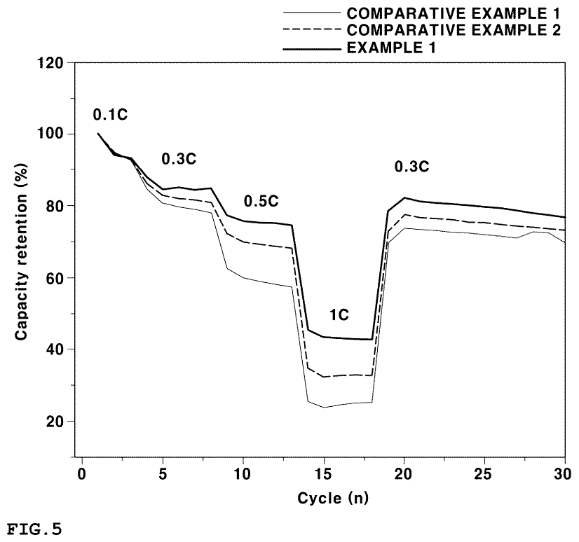

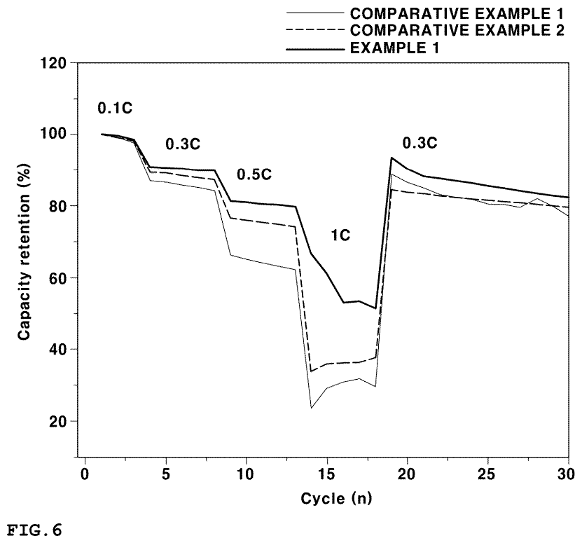

FIG. 5 shows evaluation results for each rate of the negative electrodes of the all-solid-state batteries according to Example 1 and Comparative Examples 1 and 2, where the results are obtained when each negative electrode undergoes lithiation. FIG. 6 shows evaluation results for each rate of the negative electrodes of the all-solid-state batteries according to Example 1 and Comparative Examples 1 and 2, where the results are obtained when each negative electrode undergoes dilithiation. It can be seen that rate capability is advantageous in the case of Example 1 compared to the case of Comparative Examples 1 and 2. This shows that the content of the binder, serving as a resistor for ion conduction, is minimized when forming the double layer, thus reducing resistance and improving cell output performance. This is also consistent with the results of resistance reduction shown in Table 2.

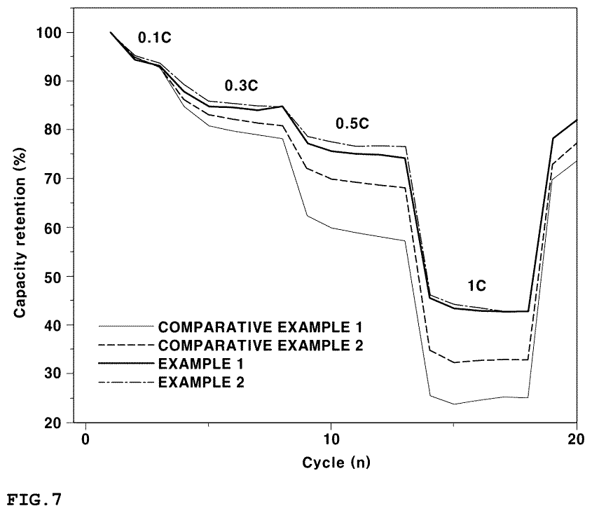

FIG. 7 shows measurement results of the capacity retention rate for each rate of the all-solid-state batteries according to Examples 1 and 2 and Comparative Examples 1 and 2. From FIG. 7, it can be seen that in the case of Examples 1 and 2, the output characteristics for each rate are superior to those in the case of Comparative Examples 1 and 2. In particular, there was a tendency in that the output performance in Example 2 was slightly improved, meaning that the energy density was increased by optimizing the thickness of the first and second layers.

Such results may be attributable to the high adhesive strength and low resistance confirmed in Table 2 earlier.

While the present disclosure has been particularly shown and described with reference to embodiments thereof, it should be understood that the scope of the present disclosure is not limited to the described embodiments. Modified forms are also included within the scope of the present disclosure.

What is claimed is:

1. An all-solid-state battery comprising:
a negative electrode current collector;
a negative electrode layer disposed on the negative electrode current collector;
a solid electrolyte layer disposed on the negative electrode layer;
a positive electrode layer disposed on the solid electrolyte layer; and
a positive electrode current collector disposed on the positive electrode layer,
wherein the negative electrode layer comprises
a first layer disposed on the negative electrode current collector, the first layer comprising a first negative electrode active material and a first binder, and
a second layer disposed on the first layer, the second layer comprising a second negative electrode active material and a second binder, and
wherein each of the first binder and the second binder comprises a nonpolar main chain and a polar functional group bound to the nonpolar main chain, and wherein in the negative electrode layer, a content of the first binder is higher than a content of the second binder.

2. The all-solid-state battery of claim 1, wherein each of the first negative electrode active material and the second negative electrode active material comprises a silicon-based negative electrode active material.

3. The all-solid-state battery of claim 1, wherein the nonpolar main chain comprises at least one of butadiene rubber, styrene-butadiene rubber, or any combination thereof.

4. The all-solid-state battery of claim 1, wherein the polar functional group comprises at least one of a carboxyl group, an acrylic group, or any combination thereof.

5. The all-solid-state battery of claim 1, wherein each of the first binder and the second binder comprises 1 percentage by weight (wt %) to 10 wt % of the polar functional group with respect to a total weight thereof.

6. The all-solid-state battery of claim 1, wherein a ratio (T₁:T₂) of a thickness (T₁) of the first layer to a thickness (T₂) of the second layer is in a range of 1:2 to 1:3.

7. The all-solid-state battery of claim 1, wherein the negative electrode layer has a thickness in a range of 20 to 100 micrometers (μm).

8. The all-solid-state battery of claim 1, wherein in the negative electrode layer, a ratio (A₁:A₂) of the content (A₁) of the first binder to the content (A₂) of the second binder is in a range of 1:0.1 to 1:0.5.
